(19) United States
(12) Patent Application Publication
(10) Pub. No.: US 2015/0020658 A1
(43) Pub. Date: Jan. 22, 2015

(54) Facial hair shaver with built-in facial hair pattern guides

(71) Applicant: Hasam Eljaouhari, Katy, TX (US)

(72) Inventor: Hasam Eljaouhari, Katy, TX (US)

(21) Appl. No.: 13/944,760

(22) Filed: Jul. 17, 2013

(51) Int. Cl. B26B 21/40

(52) U.S. Cl. CPC B26B 21/4056; B26B 21/4081
USPC 83/13; 30/34.05

(57) ABSTRACT

An apparatus for shaving facial hair comprising cutting mechanism(s) that may be guided by image capturing devices, lasers, or imaging sensors to provide a user with one of a number of pre-programmed facial bearded shapes. The apparatus may include a pre-programmed application built into the apparatus, allowing the user to select from a number of predetermined facial hair styles and designs such as of goatees, beards, and mustaches. The apparatus would only allow the cutting mechanism(s) to make contact with the surface of the face at pre-determined points identified by the selected program.

### CROSS-REFERENCE TO RELATED APPLICATIONS

This application is a Continuation-In-Part of U.S. application Ser. No. 13/874,394, entitled “Facial Hair Shaver With Built-in Facial Hair Pattern Guides”, filed Apr. 30, 2013. The disclosures of these documents are incorporated herein by reference in their entirety.

### STATEMENT REGARDING FEDERALLY SPONSORED RESEARCH OR DEVELOPMENT

Not applicable.

### BACKGROUND OF THE INVENTION

1. Field of Invention

This invention is in the field of guarded or guided facial hair trimmers.

2. Background of the Invention

A beard is a grouping or groupings of facial hair that grow on the chin, upper lip, cheeks or neck of male humans. Throughout time, beard sporting males have been attributed with various qualities such as wisdom, sexual virility or masculinity. In modern times, various beard styles have developed as elements of fashion or non-verbal expression. Exemplary styles include: a mustache, which is defined by a tuft of hair on the upper lip of an otherwise clean shaved face; a goatee, which is defined as a tuft of hair on the chin of an otherwise clean shaved face; and a Van Dyke, which is defined as a mustache plus goatee on an otherwise clean shaved face. In modern parlance, the term goatee may refer to a goatee or a Van Dyke beard style.

In view of constantly growing facial hair, men are occasionally desirous of either repeating a particular beard style or changing their beard to a new style. Usually, repeating or changing a beard style is accomplished by free hand grooming of the beard using a shaver. Problems arise in free hand grooming because untrained beard groomers ordinarily cannot consistently (a) repeat an old beard style or (b) arrive at a desired new beard style from a preexisting one. Thus, a need arises for apparatus and related methods of consistently accomplishing a desired new or old beard style of a wearer.

In view of the forgoing, various guards and stencils exist, whether alone or in combination, for controlling the length and shape of facial hair tufts that compose a beard. For example, U.S. Pat. No. 6,655,389, U.S. Pat. No. 8,082,927, U.S. Des. Pat. No. D662258, U.S. Pub. Pat. App. No. 2009/0223530, and P.C.T. Pub. App. No. WO2010/134794 disclose various embodiments of stencils or guides for facial hair shavers. However, such known stencils/guides are not adequately suited for grooming all beard styles. First, many of the devices are not adapted to guard facial features that might otherwise be exposed to injury by hair cutting razors. Second, all of the devices do not have built-in razors so that the same must used in connection with a non-stationary and free-hand razor. Finally, none of the devices feature adjustment mechanisms for altering the stencil or guard to the particular face of a user. Thus, a need still exists for apparatus and related methods of consistently accomplishing a desired new or old beard style of a wearer without the drawbacks of known stencils or guides.

### SUMMARY OF THE INVENTION

Accordingly, it is an object of the present invention to provide apparatus and related methods of consistently accomplishing a desired new or old beard style. It is another object of the present invention to provide such apparatus and related methods in a manner that protects facial features that are otherwise exposed to injury by razors. Yet still, it is an object of the present invention to disclose such apparatus and related methods wherein the apparatus have built in razors with adjustment mechanisms for adapting facial hair patterns to the particular face or preference of a user.

In one embodiment, the disclosed apparatus comprises: a canopy with a nose guard and chin guard; at least one cutting mechanism disposed on a track within the canopy, wherein the track is configured to define the outline of a beard style; and a motor for (a) operating the cutting mechanism(s) and (b) shifting the position of the cutting mechanism(s) around the track. In operation: (1) the apparatus may be stagnantly placed over the mouth area so that the nose guard is positioned beneath the nostrils of a user and so that the chin guard is placed (or cupped) against the user's chin; (2) the motor may be turned-on whereby the cutting mechanism(s) operate while traversing the track to shape the beard style; and (3) the motor may continue to run so that the cutting mechanism(s) may repeatedly move back and forth along the track until the beard style is completed. In a preferred mode of operation, the track may be adjusted to fit the contours and size of the user's face. In one embodiment, the nose and chin guards may be preferably spring mounted and adjustable so that depth of the shape may be adjusted between a clean shave and various other facial hair lengths. In yet another embodiment, the cutting mechanisms may be defined by three spring mounted rotary blades on a spring mounted track, wherein the rotary blades may be pressed against the users face. In other embodiments, different spring-mounted cutting mechanisms, such as straight razors or lasers, may be utilized along the track.

### BRIEF DESCRIPTION OF THE FIGURES

Other objectives of the invention MI become apparent to those skilled in the art once the invention has been shown and described. The manner in which these objectives and other desirable characteristics can be obtained is explained in the following description and attached figures in which:

FIG. 1A is a perspective view of a beard styling apparatus;

FIG. 1B is a right side view of beard styling apparatus;

FIG. 2 is a front view of a the beard styling apparatus;

FIG. 3 is a left-side view of the beard styling apparatus;

FIG. 4 is a back vie of the beard styling apparatus;

FIG. 5 is an operational display of the back view of the beard styling apparatus;

FIG. 6 is an environmental view of the beard styling apparatus;

FIG. 7 a schematic diagram showing blades and a track positioned on a face;

FIGS. 8A & 8B is another schematic diagram showing a track positioned on a face;

FIG. 9 is yet another schematic diagram showing a track positioned on a face;

FIG. 10 is an operational and schematic view of blades and a track positioned on a face;

FIG. 11 is a perspective view of the track as positioned on a face;

FIG. 12 is a side perspective view of the apparatus showing the track and canopy placed against a face;

FIG. 13 is an alternate embodiment of the beard styling apparatus;

FIG. 14 is an operation display of the apparatus of FIG. 13;

FIG. 15 is another embodiment of the beard styling apparatus;

FIG. 16 is an operational display of the apparatus of FIG. 15;

FIG. 17 is an alternative embodiment of the beard styling apparatus;

FIG. 18 is an operational display of the apparatus of FIG. 17;

FIG. 19 is a perspective view of the apparatus of FIG. 17.

FIG. 20 is a perspective view of the apparatus showing a user interface.

FIG. 21 is a flowchart representing the logic flow of a preferred embodiment of the apparatus.

It is to be noted, however, that the appended figures illustrate only typical embodiments of the disclosed apparatus and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed are apparatus and related methods of consistently accomplishing a desired new or old beard style. The disclosed apparatus and related methods accomplish said beard styles in a manner that protects facial features which would otherwise be exposed to injury by hair cutting mechanisms. Yet still, the disclosed apparatus have built in razors with adjustment mechanisms for adapting facial hair patterns to the particular face or preference of a user.

In general, the disclosed apparatus comprises: a canopy that houses (i) a nose guard for supporting and aligning the apparatus to the nostrils and upper lip of a user, (ii) a chin guard for stabilizing and supporting the apparatus to the chin of the user, and (iii) a track that supports at least one cutting mechanism, wherein the track is configured to define the outline of a beard style; and a motor for (a) operating the cutting mechanism(s) and (b) shifting the position of the cutting mechanism(s) along the track. The more specific features of the apparatus are further disclosed in connection with the figures.

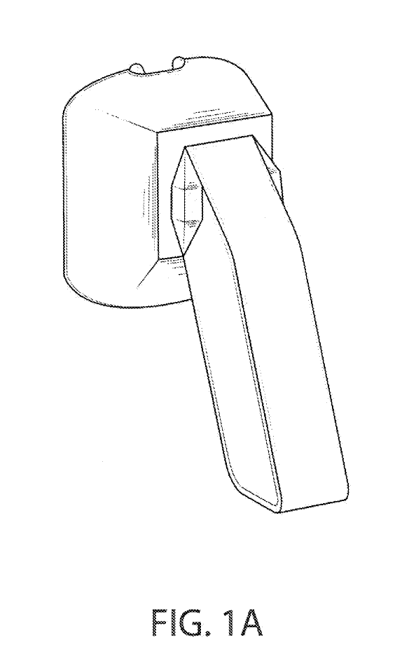

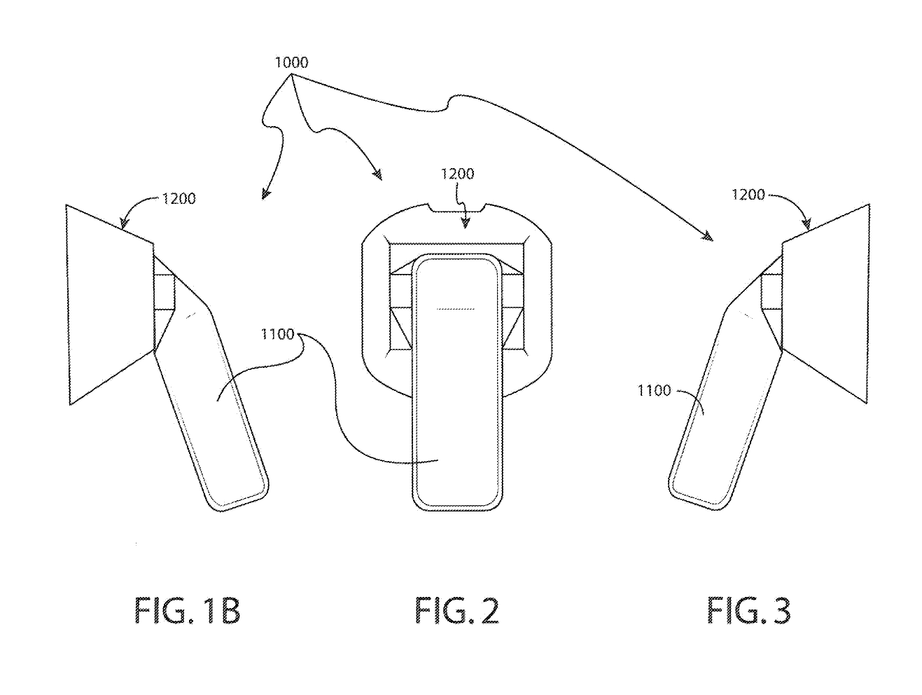

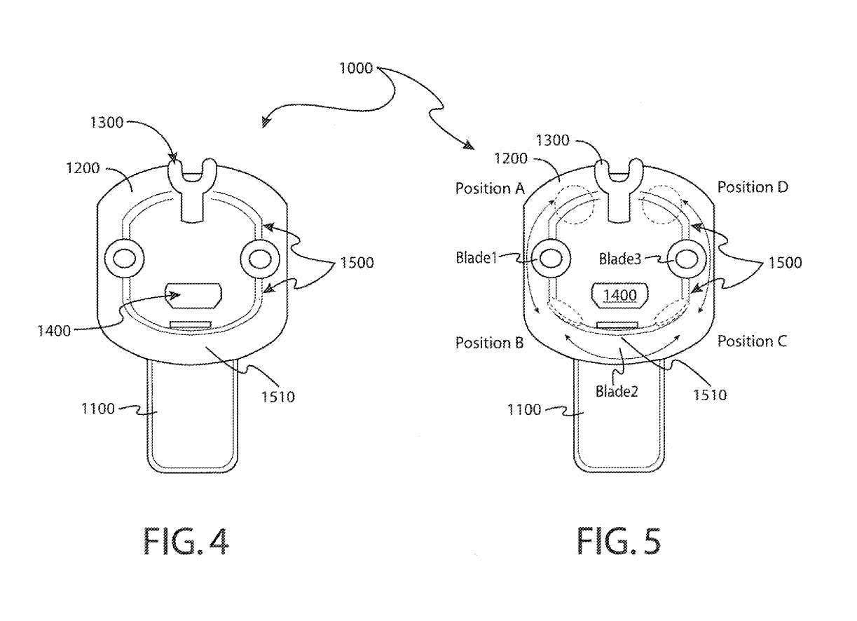

FIGS. 1A through 4 respectively depict a perspective view, a right side view, a front view, a left-side view, and a back view of a preferred beard styling apparatus 1000. Referring to said figures, the apparatus 1000 features: a handle 1100 with an internal motor (not shown); a canopy 1200; a nose guard 1300; a chin guard 1400; a spring mounted track 1500 with three spring mounted rotary blades 1510 that are movably secured to the track 1500. The canopy 1200 is preferably a firm yet slightly flexible structure (e.g., made from hard rubber or plastic like substances). In use, the canopy 1200 may encompass the cutting area of the device and, as discussed in greater detail below, is configured to sit stationary against the face of a user. Preferably, the canopy 1200 further houses (i) the nose guard 1300 so that the nose guard may support and align the apparatus to the nostrils and upper lip of a user, (ii) the chin guard 1400 for stabilizing and supporting the apparatus to the chin of the user, and (iii) the track 1500 that supports the rotary blades 1510, wherein the track 1500 is spring mounted and configured to define the outline of a beard style. Suitably, the spring mounted rotary blades 1510 are configured for compression against the face of a user during operation, wherein the blades are spring mounted so that the blades may be continually placed against the face of a user and wherein the track is spring mounted so that the blades may be aligned or adjusted to the contours of the user's face. As discussed in further detail below, the motor (not shown) is disposed within the handle 1100 and is coupled to the rotary blades 1510 to drive both the rotation of the rotary blades 1510 and movement of the same 1510 along the track 1500. Although not shown, motion of the rotary blades may be driven by, for instance, a series of gears with teeth, springs, and other mechanisms. Such coupling of the motor to the blades for rotational and track movement will be well known to those of skill art.

FIG. 5 is an operational display of the back view of the beard styling apparatus. More specifically, FIG. 5 is an illustration of a preferred mode of operation for the rotary blades 1510 of the apparatus, wherein each blade oscillates between two of four positions on the tracks. In one embodiment: a first rotary blade, Blade1, oscillates along the track 1500 between position A and B shown in broken lines; a second rotary blade, Blade2, oscillates along the track 1500 between positions B and C shown in broken lines; and a third rotary blade, Blade3 oscillates along the track 1500 between positions C and D shown in broken lines. Suitably, the first, second and third blades Blade1, Blade2, Blade3 would be in sync such that: (a) the first blade is in position A while the second blade is in position B and the third blade is in position C; and (b) the first blade is in position B while the second blade is in position C and the third blade is in position D. While oscillating, it is contemplated that the blades 1510 are also rotating to cut facial hair passed over during said oscillations. In a preferred embodiment, the oscillations of the first through third blades overlap (e.g. B and C define overlapping positions). As discussed above, the motor (not shown) is configured to drive both the oscillations and rotation of the blades 1510.

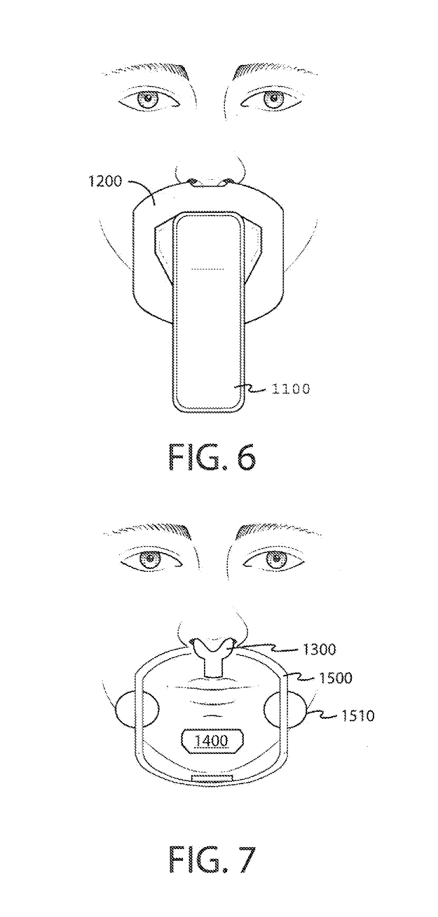

FIG. 6 is an environmental view of the beard styling apparatus 1000. Specifically the figure illustrates the front view of the apparatus 1000 as it is preferably placed against the face of a user in the operating position. As discussed in greater detail below, once the apparatus 1000 is placed along the user's face, as shown, the apparatus 1000 preferably does not move after being turned on because the blades are moving internally relative to the user's face. To avoid any disruption in the beard style pattern created by the apparatus, the lips and mouth of the user should remain still while the apparatus 1000 is on.

FIG.7 a schematic diagram showing the blades 1510 and a track 1500 being positioned on a face of a user. The figure illustrates how the tracks 1500 (guiderails) are preferably positioned when the apparatus 1000 is placed against the face of a user, in an operating position. The figure also shows how the nose guard 1300 and chin guard 1400 are preferably positioned along the face to stationarily stabilize the apparatus 1000 against the face. The apparatus must be aligned against the face (prior to turning the electric shaver on) with the nose guard positioned against the nostrils and upper lip indentation as indicated. More specifically, the chin guard 1400 may suitably be placed against the user's chin while the nose guard 1300 is positioned under the nostrils of the user's nose so as to center the apparatus 1000 and stabilize the same against the user's face. Once the chin and nose guards 1400, 1300 are so positioned, the apparatus 1000 may suitably remain stagnant, held in place by the individual's hand, and compressed against the user's face. After stabilization of the apparatus 1000, the apparatus can be turned on, allowing the oscillating blades to move along the tracks and cut facial hair automatically in their path.

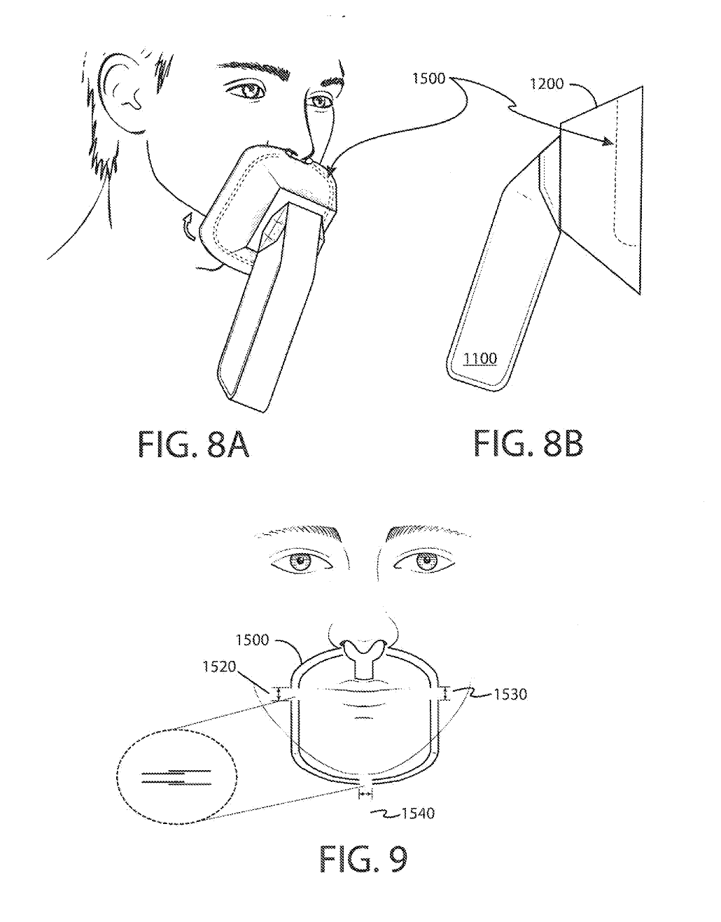

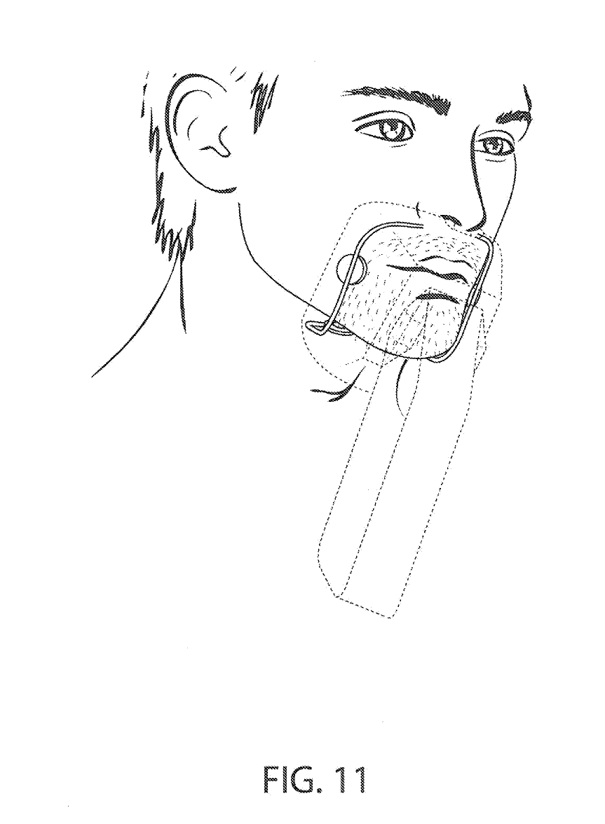

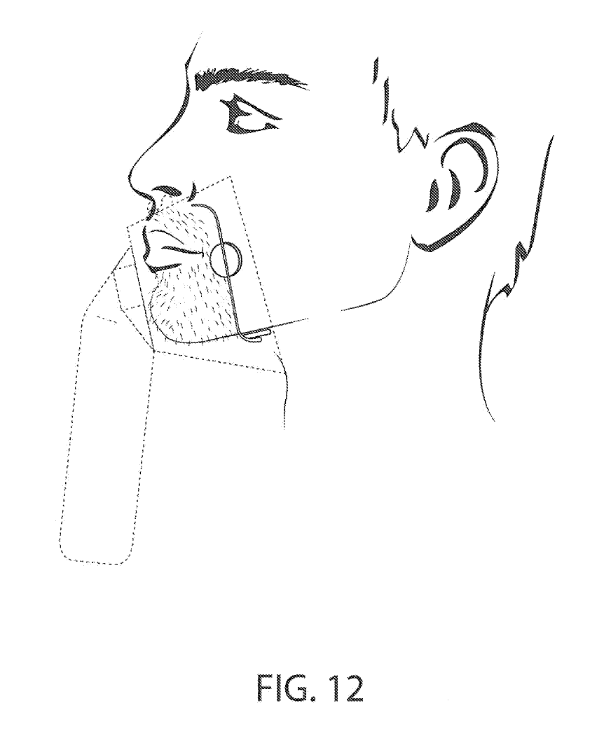

FIGS. 8A and 8B are another schematic diagram showing a track positioned on a face. As shown the track 1500 may be suitably formed or configured to bend or adjust to the contours of a face. FIGS. 11 and 12 further illustrate that, in the preferred embodiment, the track bends under the user's chin so that the blade may remain flush against the skin on the underside of the chin and according to the beard style pattern. As depicted in a perspective side view of a user operating the apparatus in FIGS. 11 and 12, the track and blades are positioned stagnantly against a user's face according to a goatee style facial hair pattern.

FIG. 9 is yet another schematic diagram showing a track positioned on a face. As shown, the track 1500 may suitably be widened and lengthened to fit the dimensions of a specific user's face. FIG. 9 illustrates how the tracks 1500(guiderails) would be positioned when the apparatus is placed against the face, he operating position. In a preferred embodiment, the track 1500 features three adjustment points, 1520, 1530, 1540 wherein sectioned rails of the track may slide relative to other rails to accomplish adjustment. In operation, the first two adjustment points 1520, 1530 (working in unison) are suitably for elongating the track 1500 while the third adjustment point 1540 is suitably for widening the track. Such elongation or widening of the track allow a user to adjust the track 1500 to the user's facial dimensions or beard style preferences. Suitably, the actual adjustment mechanism can be done in a number of ways, for example, using a threaded rotating screw-like mechanism to bring the guiderails closer together or further apart or a mechanism with latching teeth to allow for a number setting, cocking each latch to bring the guiderails closer or further apart, locking into the teeth.

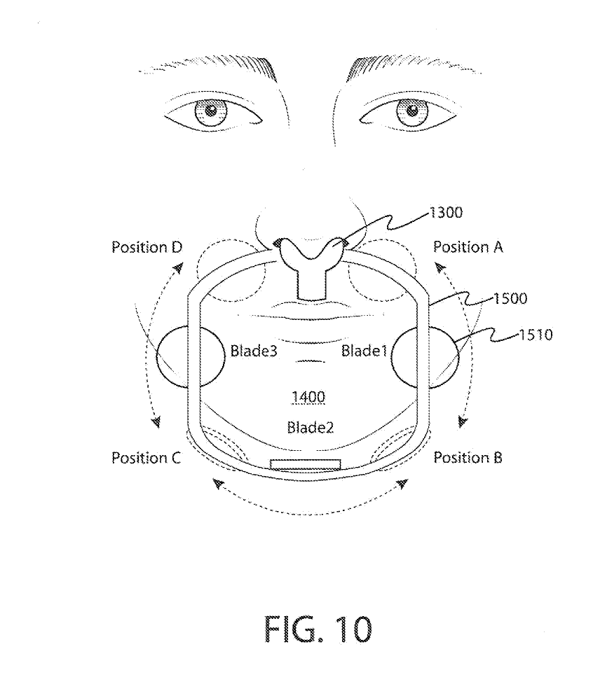

FIG. 10 is an operational and schematic view of blades and a track positioned on a face. In operation: (1) the track 1500 may suitably be adjusted to the dimensions of the user's face or beard style preference; (2) the apparatus may be stationarily placed over the mouth area so that the nose guard is positioned beneath the nostrils of a user and so that the chin guard is placed (or cupped) against the user's chin; (2) the motor may be turned-on whereby the cutting mechanism(s) operate while traversing the track to shape the beard style; and (3) the motor may continue to run so that the cutting mechanism(s) may repeatedly move back and forth along the track until the beard style is completed. In a preferred mode of operation, the track may be adjusted to fit the contours and size of the user's face. In one embodiment, the nose and chin guards may be preferably spring-mounted and adjustable so that depth of the shape may be adjusted between a clean shave and various other facial hair lengths. In other embodiments, different cutting mechanisms, such as straight razors or lasers, may be utilized along the track.

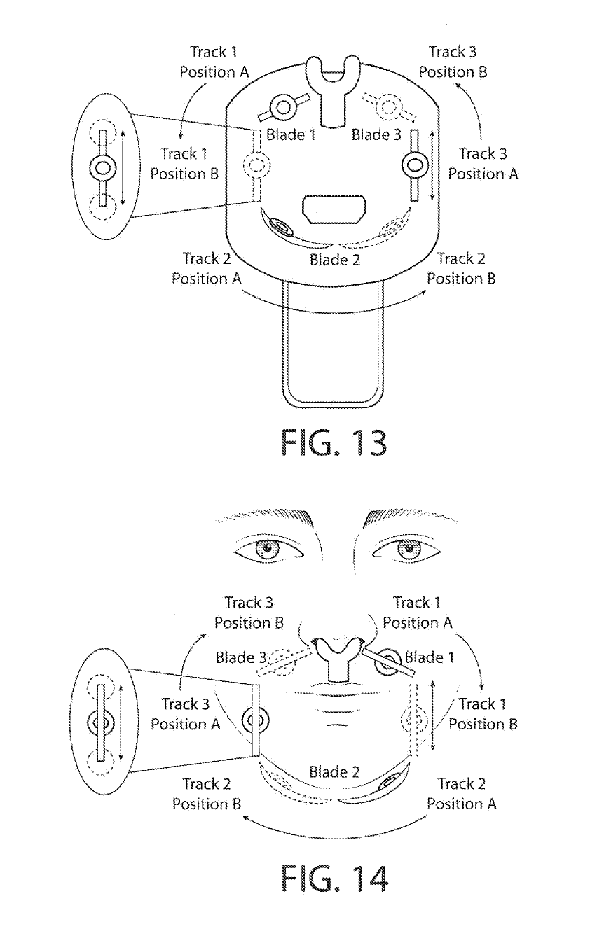

FIGS. 13 and 14 illustrate an alternate embodiment of the beard trimming apparatus. Generally, the depicted embodiment operates as disclosed above in connection with the earlier figures. However, the track 1500 is divided into three sections, respectively identified as track 1, 2 and 3. Suitably, the tracks move back-and-forth between positions A and B while the blades oscillate across the individual tracks (as shown in the blow-out view).

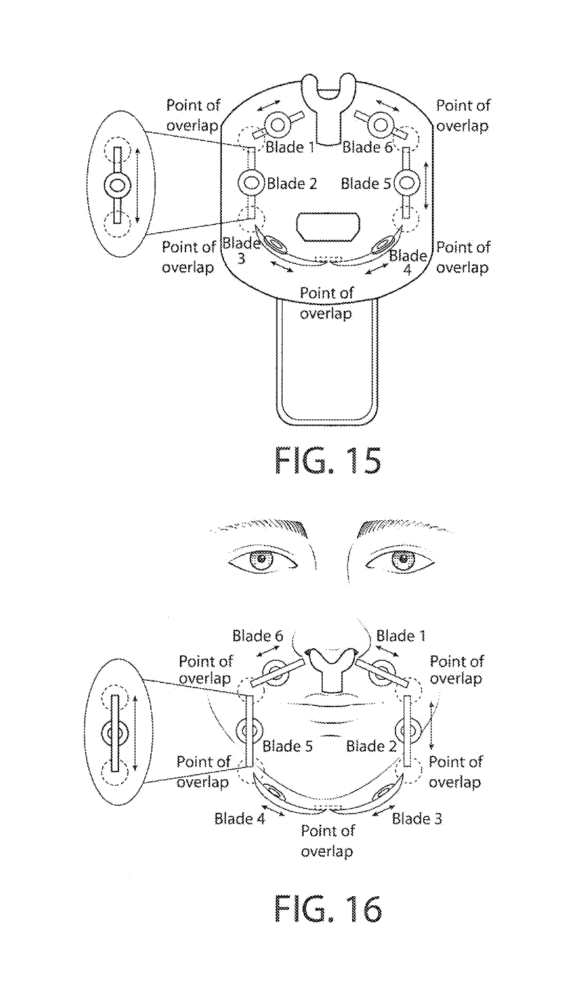

FIGS. 15 and 16 illustrate another alternate embodiment of the beard trimming apparatus. In general, the depicted embodiment operates like the earlier disclosed embodiments. However, the track is divided into six stationary sections. Suitably, Blades 1-6 oscillate across their respective tracks. In a preferred embodiment, the oscillation of Blades 1-6 may be synchronized so that the blade paths overlap to ensure the full beard pattern is cut into the facial hair of the user.

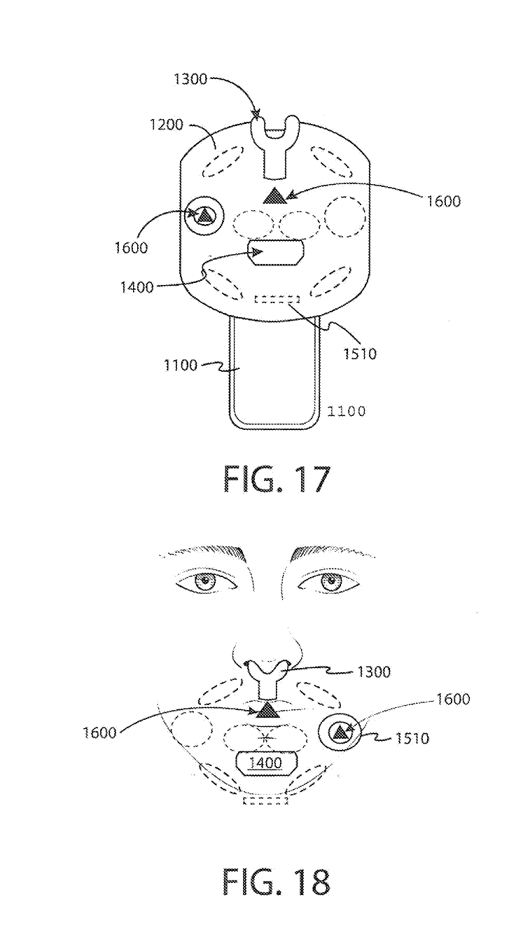

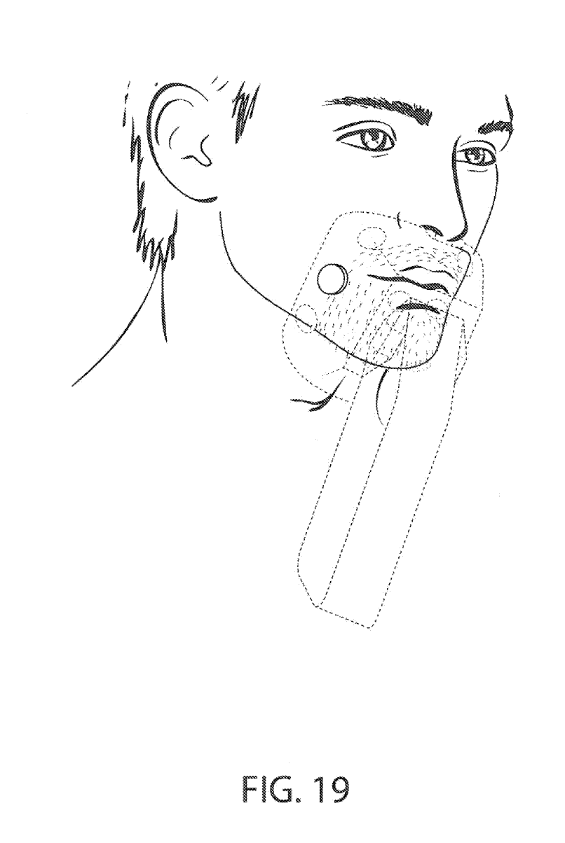

FIGS. 17, 18, and 19 illustrate another alternate embodiment of the beard trimming apparatus. In general, the depicted embodiment employs image capturing sensors 1600 to collect facial characteristic data of the user's face. Preferably, this embodiment does not feature a track. This embodiment employs image capturing devices, facial recognition, and sensing means to provide a number of pre-programmed facial hair shapes. The cutting mechanisms roam within the canopy (sometimes referred to as the “cutting field”) to achieve the desired facial hair pattern. Further, the cutting mechanisms may be guided by the sensors after or during the collection of facial characteristic data. The combination of images from both the image capturing device 1600 on the inside center of the canopy and the image capturing device(s) 1600 on each cutting mechanism(s) allows for identification of the facial dimensions and position, relative to the identified points (i.e. corners of the mouth, chin guard, nose guard), as well as the outer edge of the canopy lining.

Referring to FIGS. 17 and 18, the apparatus may comprise: a canopy 1200 with some stabilizing points, such as a nose guard 1300 and chin guard 1400; at least one cutting mechanism 1510 such as a blade or laser, disposed within the canopy 1200; an image capturing device 1600 on the inside center of the canopy, as well as on each cutting mechanism 1510 (image capturing devices would also utilize sensing means to measure depth and distance from a specific point); and a motor for (a) operating the cutting mechanism(s) and (b) maneuvering the position of the cutting mechanism(s) 1510 in relation to a specific identified point(s). Sensing means for gathering biometric and positional data may include imaging sensors, sensor arrays, digital sensors, force sensors, infrared sensors, biosensor, biotranducers, transducers, piezoelectric sensors, pyroelectric sensors, inductive sensors, capacitive sensors, electromechanical film, displacement receivers, strain gauges, pressure sensors, intelligent sensors, CMOS active pixel sensors, catadioptric sensors, laser sensors, staring arrays, ultrasonic sensors, or sonar sensors. Such sensors are preferably adapted to detect characteristics of a user's face and biometric characteristics which data may be harnessed by programs that control the cutting mechanisms.

To operate such an embodiment as shown in FIGS. 17 and 18, the user will select a specific facial hair style from a number of predetermined designs (i.e. various types of goatee, van dyke) that may be stored in a database 2000 (not shown) and that will be the basis of the template in which the apparatus will utilize to shape the desired facial hair style. This selection may be made from a pre-programmed application built into the apparatus. Next, the apparatus may be placed over the mouth area so that the nose guard 1300 is positioned beneath the nostrils of a user and so that the chin guard 1400 is placed (or cupped) against the user's chin. The image capturing device 1600 on the inside center of the canopy then captures the image beneath the canopy and utilizes sensors to measure depth and distances (utilizing reflections of various points of the face and reading those reflections with the sensors) from a specific identified point(s). Specific identified points may include the corners of the mouth, the nose guard, or the chin guard. Sensing means may include laser reflections of various points of the face and reading those laser reflections back to the device. Sensing means may also include imaging sensors, sensor arrays, digital sensors, force sensors, biosensor, biotranducers, transducers, piezoelectric sensors, pyroelectric sensors, inductive sensors, capacitive sensors, electromechanical film, displacement receivers, strain gauges, pressure sensors, intelligent sensors, CMOS active pixel sensors, catadioptric sensors, laser sensors, staring arrays, ultrasonic sensors, or sonar sensors. Such sensors detect user characteristics and store the data regarding the same.

Still referring to FIGS. 17 and 18, an image capturing device 1600 on each cutting mechanism(s) 1510 would also utilize sensing means to measure depth and distance from the same specific identified point(s) as well as other points of the face (utilizing laser reflections of various points of the face and reading those laser reflections with the sensors). The image capturing device 1600 on each cutting mechanism(s) 1510 will capture the image beneath the canopy and utilize sensing means to measure depth and distances (utilizing laser reflections of various points of the face and reading those laser reflections with the sensors) from a specific identified point(s). Sensing means may include laser reflections of various points of the face and reading those laser reflections back to the device. Sensing means may include imaging sensors, sensor arrays, digital sensors, force sensors, biosensor, biotranducers, transducers, piezoelectric sensors, pyroelectric sensors, inductive sensors, capacitive sensors, electromechanical film, displacement receivers, strain gauges, pressure sensors, intelligent sensors, CMOS active pixel sensors, catadioptric sensors, laser sensors, staring arrays, ultrasonic sensors, or sonar sensors. Specific identified points may include the corners of the mouth, the nose guard, or the chin guard.

Still referring to FIGS. 17 and 18, the motor may be turned-on whereby the cutting mechanism(s) 1510 operate while traversing and maneuvering to shape the facial hair style, cutting and shaping based on the selected predetermined style and design of the facial hair (i.e. various types of goatee, van dyke, etc.), taking into account the measurements and dimensions of the cutting field captured by the combination of images from both the image capturing device on the inside center of the canopy 1200 and the image capturing device on each cutting mechanism, identifying the facial dimensions and position, relative to the identified points (i.e. corners of the mouth, chin guard, nose guard, edge of canopy lining). All the time, the cutting mechanism(s) may be continuously guided by laser reflections, distance measurements and depth perceptions provided by the sensors. This data may be utilized against the selected predetermined style and design of the facial hair program that was selected, while only allowing the cutting mechanism(s) 1510 to make contact with the surface of the face at pre-determined points identified by the selected program. The motor may continue to run so that the cutting mechanism(s) 1510 may repeatedly traverse and maneuver along the identified path until the facial hair style is completed. Alternatively, the motor may activate or deactivate when necessary for cutting. The cutting mechanism(s) 1510 have the ability to roam within the canopy 1200, guided by reflections, distance measurements and depth perceptions, provided by the imaging sensors, limited by the predetermined style and design of the facial hair program that is selected and only allowing the cutting mechanism(s) to make contact with the surface of the face at pre-determined points identified by the selected program.

In some embodiments of the apparatus found in FIGS. 17 and 18, each cutting mechanisms may operate within a six axis degree of freedom environment. Preferably, each cutting mechanism may be attached to a robotic arm. The robotic arms are configured for automated control in three spatial dimensions plus roll, yaw, and pitch. Each arm may be coupled to a controller for controllably positioning the cutting mechanism within a three dimensional coordinate system. The system may further include algorithms for determining the position of the cutting mechanism in the three dimensional coordinate system relative to a predetermined facial area. In such embodiments, the predetermined facial area is defined by input boundaries determined by the image capturing devices during placement of the apparatus on the user's face. The controller may include a device for detecting a location of the cutting mechanism, such as an optical tracking system disposed for imaging a region of space that includes at least a part of the arm or the cutting mechanism. The tracking system may be coupled to a processor that processes the volumetric model for determining if the cutting mechanism is positioned outside of a predetermined facial area. The system may further include redundant safety checks including a strain gauge for detecting any interference between the user's face and a reference point, as well as an attendant safety stop to prevent any cutting of the face. The multiple and redundant safety devices are employed for suspending a motion of the robotic arm to prevent the cutting mechanism from operating beyond the limitations of the user's facial area.

Referring to the embodiment above, the optical tracking system may include a camera with a plurality of spatially separated image sensors. The camera may be coupled to a camera processor that visually tracks in three dimensions the position and orientation of a plurality of image sensors that are mounted on or within a reference plane of each cutting mechanism. Output positions may be calculated by the optical tracking system in real time. An output of the optical tracking system may be coupled to a safety monitoring processor t hat has the task of verifying that the cutting mechanism remains within the predetermined spatial volume associated with the selected facial hair pattern. In some embodiments, a processor receives the coordination transformation of the above mentioned reference plane relative to the camera from the camera processor. Alternative embodiments may include the use of other sensing means either for direct measurement of the cutter mechanism position or as feedback allowing the controller to place the cutting mechanism in a known position relative to a reference landmark or coordinate system. Reference landmarks may include but are not limited to the nose, chin, lips, cheekbones, or ears.

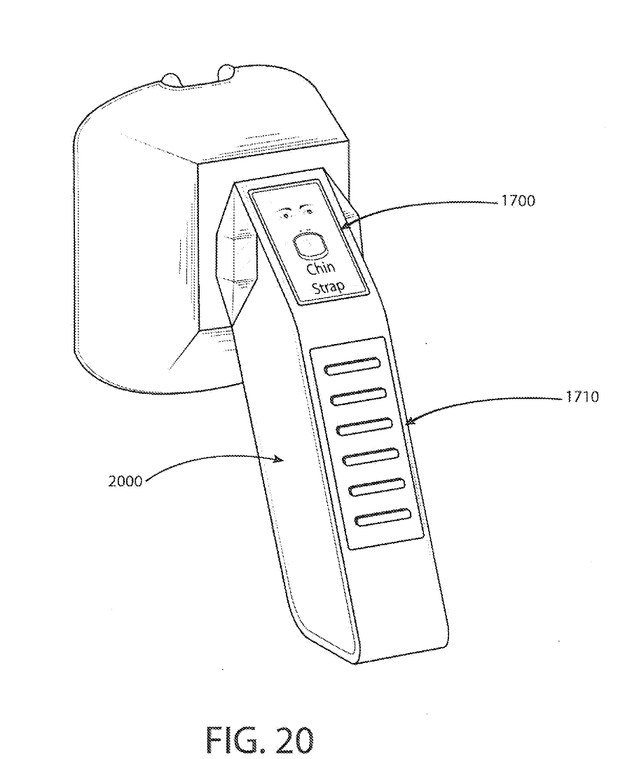

FIG. 20 illustrates an alternate embodiment of the beard trimming apparatus featuring a touchscreen panel. The touchscreen panel may be used to select a facial hair style from a list of facial hair styles. Alternatively, a control panel featuring buttons may be used to select a facial hair style from a list of facial hair styles. The preprogramed facial hair shapes may include but are not limited to a beard, goatee, goatee sans mustache, chinstrap, chin strip, soul patch, mutton chops, balbo, mustache, handlebar mustache, scruff, trimmed scruff, chinless beard, door knocker, goatee with chin strap, chin curtain, French cut goatee, Fu Manchu, Horseshoe Mustache, neckbeard, pencil mustache, stubble, toothbrush mustache, or Van Dyke beard. Alternatively, the selection will occur at a charging station adjacent the shaver.

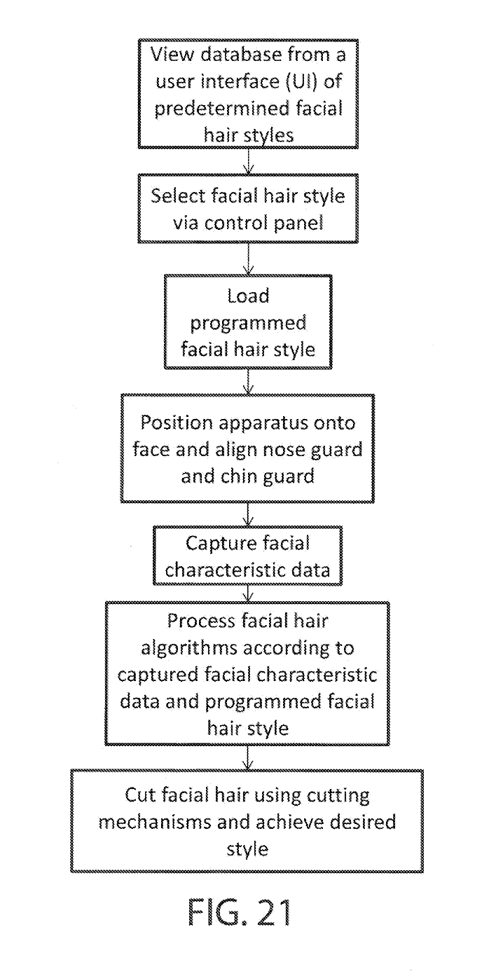

FIG. 21 depicts a flowchart representing the logic flow of a preferred embodiment of the apparatus. The user may view the database of predetermined facial hair styles from a user interface. User interfaces may be operated from the shaver, a dock, a charging station, an adjacent structure, a computer, social media, or a cellular device. Additional facial hair patterns may be added to the database via electronic connection. Next, the user will select a facial hair style from a control panel. The control panel may be located on the shaver, a dock, a charging station, an adjacent structure, a computer, social media, or a cellular device.

Upon selection of the facial hair style, the pre-determined program will automatically load the programmed facial hair style that was selected by the user. After selection of the facial hair style, the user positions the apparatus on his or her face. Next, the apparatus may capture facial hair characteristic data from the user and include with or compare with the pre-loaded programmed facial hair style that was selected by the user. The apparatus may then process the facial characteristic data and utilize software algorithms to match the facial hair characteristic data with the programmed facial hair style. The algorithms may manage data collected from sensors, compare the data against templates of facial hair patterns, and then tracks progress of the cutting mechanisms as they achieve the desired facial hair pattern. The algorithms may guide the apparatus to cut the user's facial hair using cutting mechanisms and achieve the desired pattern.

Other assembly methods may be practiced depending on the use of alternative embodiments described herein, and will be readily apparent to those skilled in the art.

I claim:

1. An apparatus for shaving facial hair comprising:
a canopy;
sensing means disposed within said canopy;
cutting mechanisms disposed within the canopy, wherein the cutting mechanisms are configured to shave facial hair according to data captured by said sensing means and according to a particular facial hair pattern; and
wherein said facial hair style is selected from a list of facial hair styles in a computing device.

2. The apparatus of claim 1, wherein the sensing means are located within the canopy.

3. The apparatus of claim 1, wherein the sensing means are located on the cutting mechanisms.

4. The method of claim 1, wherein said cutting mechanisms roam within the canopy and are guided by said data captured by sensing means.

5. The method of claim 1, wherein the cutting mechanisms are coupled to at least one six-axis robotic arm.

6. The method of claim 5, wherein the six-axis robotic arm is coupled to a controller which positions the cutting mechanism according to the predetermined facial hair pattern.

7. The apparatus of claim 1, further comprising a screen panel for selection of the facial hair style.

8. The apparatus of claim 1, further comprising a control panel to select the facial hair style.

9. The apparatus of claim 1, wherein the data captured by said sensing means is implemented at specific points of a user's face.

10. The apparatus of claim 1, further comprising an electronic dock to select the facial hair style.

11. The apparatus of claim 8, wherein said electronic dock has charging means to charge the apparatus.

12. A method of shaving comprising:
selecting a predetermined facial hair pattern from an electronic database;
measuring a user's facial characteristics via sensors; and
having said sensors communicate data about facial characteristics with cutting mechanisms on a user's ace to achieve cutting said facial hair pattern.

13. The method of claim 12, wherein the sensors are located within a canopy of a shaving apparatus.

14. The method of claim 12, wherein the cutting mechanisms are located within a canopy of a shaving apparatus.

15. The method of claim 14, wherein the sensors are located on the cutting mechanisms.

16. The method of claim 12, wherein the cutting mechanisms are coupled to at least one six-axis robotic arm.

17. The method of claim 16, wherein the six-axis robotic arm is coupled to a controller which positions the cutting mechanism according to the predetermined facial hair pattern.

18. The method of claim 12 wherein the sensors are configured to detect a certain level of interference between the cutting mechanism and the user's face.

19. The method of claim 12 further comprising capturing images of the user's face at specified points using at least one image capturing device.

20. The method of claim 12, wherein the predetermined facial hair pattern is selected from the group consisting of beard, goatee, goatee sans mustache, chinstrap, chin strip, soul patch, mutton chops, balbo, mustache, handlebar mustache, scruff, trimmed scruff, chinless beard, door knocker, goatee with chin strap, chin curtain, French cut goatee, Fu Manchu, Horseshoe Mustache, neckbeard, pencil mustache, stubble, toothbrush mustache, and Van Dyke beard.
